(19) United States
(12) Patent Application Publication
(10) Pub. No.: US 2024/0332572 A1
(43) Pub. Date: Oct. 3, 2024

(54) FUEL CELL SYSTEM

(71) Applicant: HONDA MOTOR CO., LTD., TOKYO (JP)

(72) Inventors: Tomoyuki INOUE, WAKO-SHI (JP); Yuto NAKATANI, WAKO-SHI (JP)

(21) Appl. No.: 18/588,613

(22) Filed: Feb. 27, 2024

(30) Foreign Application Priority Data
Mar. 27, 2023 (CN) 202310312559.7

(51) Int. Cl. H01M 8/04664; H01M 8/04303; H01M 8/0438; H01M 8/04537; H01M 8/04746; H01M 8/04858

(52) U.S. Cl. CPC H01M 8/04686; H01M 8/04303; H01M 8/04388; H01M 8/04559; H01M 8/04753; H01M 8/0494; H01M 2250/20

(57) ABSTRACT

In a state in which an inlet side sealing valve and an outlet side sealing valve are driven and placed in a closed state, in the case that a fuel gas is newly supplied to an anode flow path after having completed an electrical power generation process at a time of stoppage, when an output voltage of a fuel cell is detected by a voltage sensor and the detected output voltage is greater than or equal to a threshold voltage value, it is determined that the inlet side sealing valve or the outlet side sealing valve is in an abnormal state of being in an open state.

### CROSS-REFERENCE TO RELATED APPLICATIONS

This application is based upon and claims the benefit of priority from Chinese Patent Application No. 202310312559.7 filed on Mar. 27, 2023, the contents of which are incorporated herein by reference.

### BACKGROUND OF THE INVENTION

### Field of the Invention

The present invention relates to a fuel cell system that generates electrical power by way of an electrochemical reaction that takes place between a fuel gas and an oxygen-containing gas.

### Description of the Related Art

In recent years, in order to ensure more people access to affordable, reliable, sustainable, and advanced energy, research and development have been conducted in relation to fuel cells (FC) that contribute to energy efficiency.

For example, in JP 2008-153079 A, there is disclosed an abnormality determination process for an air inlet shutoff valve (21) and an air outlet shutoff valve (22) of a fuel cell system (refer to paragraph of JP 2008-153079 A). In such an abnormality determination process, in the case that the fuel cell system is stopped, both the air inlet shutoff valve (21) and the air outlet shutoff valve (22) are placed in a closed state by a control signal. Regardless of the shutoff valves being in a closed state, at a time when deterioration of a cathode is detected, a determination is made that the air inlet shutoff valve (21) and the air outlet shutoff valve (22) are abnormal (refer to the abstract of JP 2008-153079 A).

### SUMMARY OF THE INVENTION

Incidentally, in the fuel cell system disclosed in JP 2008-153079 A, at a time when the fuel cell system is stopped, in the case that the air inlet shutoff valve (21) and the air outlet shutoff valve (22) are not placed in a closed state in a normal manner, air passes through a shut off valve that is malfunctioning, and enters into the cathode from the exterior.

When this occurs, carbon contained in the cathode is oxidized, and the potential of the cathode becomes higher than the potential at a time when the fuel cell system is in operation. In JP 2008-153079 A, it is stated that by detecting such a high potential, it is possible to reliably detect that the air shutoff valves are not in a normally closed state (refer to paragraphs and of JP 2008-153079 A).

However, the generation of a high potential caused by carbon oxidation poses a problem in that it is difficult to detect the leakage of a minute amount of air, such as when the air shutoff valves are stuck in a state in which the valve opening thereof is small.

The present invention has the object of solving the aforementioned problem.

A fuel cell system configured to generate electrical power by way of an electrochemical reaction taking place between an oxygen-containing gas passing through an inlet side sealing valve from an air compressor and being supplied to a cathode flow path along a cathode of a fuel cell, and a fuel gas supplied from a fuel tank to an anode flow path along an anode of the fuel cell, wherein an oxygen-containing off gas after the generation of electrical power passes through an outlet side sealing valve and flows to the exterior, the fuel cell system comprising: a voltage sensor configured to detect an output voltage between the anode and the cathode; and at least one processor configured to execute computer-executable instructions stored in a memory; wherein the at least one processor executing the computer-executable instructions causes the fuel cell system to: continue to generate electrical power at a time when the system is stopped, and after having consumed the oxygen-containing gas remaining from an outlet side of the inlet side sealing valve to an inlet side of the outlet side sealing valve, together with driving the inlet side sealing valve and the outlet side sealing valve to place the inlet side sealing valve and the outlet side sealing valve in a closed state, carry out an electrical power generation process at a time of stoppage in which the supply of the fuel gas from the fuel tank to the anode flow path is suspended; and determine that the inlet side sealing valve or the outlet side sealing valve is in an abnormal state of being in an open state when the output voltage is detected by the voltage sensor and the detected output voltage is greater than or equal to a threshold voltage value, in the case that the fuel gas is newly supplied to the anode flow path after having completed the electrical power generation process at the time of stoppage, in a state in which the inlet side sealing valve and the outlet side sealing valve are driven and placed in the closed state.

According to the present invention, at the time when the system is stopped, the electrical power generation process at the time of stoppage is carried out in which the fuel cell system continues the generation of electrical power, and the oxygen-containing gas within the cathode is consumed, together with the fuel gas being retained in the anode flow path. Due to the generation of electrical power at the time of stoppage, at a time of soaking after the electrical power generation process at the time of stoppage, the fuel gas is diffused from the anode flow path into the cathode flow path through a membrane electrode assembly.

In a state in which the inlet side sealing valve and the outlet side sealing valve have been driven to be placed in a closed state, and further, in a state in which the fuel gas was diffused into the cathode flow path at the time of soaking, the fuel gas is newly supplied to the anode flow path. A determination is made as to whether or not the output voltage detected by the voltage sensor at the time when the fuel gas is newly supplied to such an anode flow path has become greater than or equal to a threshold voltage value. By means of such a determination result, even at a time when a minute leakage occurs, it is possible to reliably detect whether or not an abnormality has occurred at the inlet side sealing valve or the outlet side sealing valve. In turn, the present invention contributes to energy efficiency.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a fuel cell vehicle in which a fuel cell system according to an embodiment of the present invention is incorporated;

FIG. 2 is a flowchart provided to describe operations of the fuel cell system;

FIG. 3 is a timing chart illustrating an example of a process at a time of stoppage;

FIG. 4 is an explanatory diagram of electrical current and voltage characteristics of a fuel cell stack used for explaining a threshold voltage value and the like;

FIG. 5 is a schematic explanatory diagram of operations in the case that both an inlet sealing valve and an outlet side sealing valve are determined to be normal;

FIG. 6 is a schematic explanatory diagram of operations in the case that the inlet sealing valve or the outlet side sealing valve is determined to have a sealing function abnormality; and

FIG. 7 is a time chart showing a plurality of exemplary operations, which are provided to describe an abnormality determination process for the inlet side sealing valve and the outlet side sealing valve.

### DETAILED DESCRIPTION OF THE INVENTION

### Embodiment

### Configuration

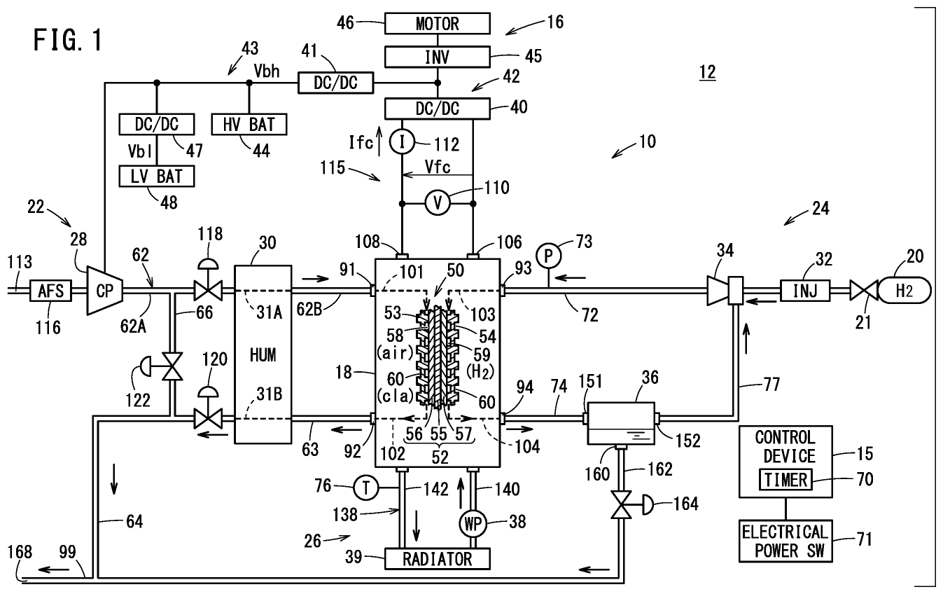

FIG. 1 is a schematic diagram of a fuel cell vehicle 12 in which a fuel cell system 10 according to an embodiment of the present invention is incorporated.

The fuel cell system 10 can also be incorporated into other moving objects such as ships, flying bodies such as aircraft or the like, and robots or the like other than the fuel cell vehicle 12.

The fuel cell vehicle 12 is constituted from the fuel cell system 10, an output unit 16 electrically connected to the fuel cell system 10, and a control device 15 that controls the fuel cell vehicle 12 as a whole (including the fuel cell system 10 and the output unit 16).

The control device 15 need not necessarily be one single control device, but may be divided into two or more control devices, for example, one used for the fuel cell system 10 and one used for the output unit 16.

The fuel cell system 10 is constituted from a fuel cell stack (also simply referred to as a fuel cell) 18, a fuel tank (a hydrogen tank, a fuel gas tank) 20, an oxygen-containing gas supply device 22, a fuel gas supply device 24, and a coolant supply device 26.

The oxygen-containing gas supply device 22 includes a compressor (CP) 28 that is an air compressor, and a humidifier (HUM) 30.

An injector (INJ) 32, an ejector 34, and a gas-liquid separation device 36 are included in the fuel gas supply device 24. The injector 32 may be replaced by a pressure reducing valve.

A coolant pump (WP) 38 and a radiator 39 are included in the coolant supply device 26.

A voltage conversion unit 42, an electrical power storage unit 43, and a motor (electric motor) 46 are included in the output unit 16.

An inverter 45, a DC/DC converter (SUC) 40 that is a step-up converter, and a DC/DC converter (SUDC) 41 that is a step-up/step-down converter are included in the voltage conversion unit 42.

A high voltage electrical power storage device (high voltage battery, HV BAT) 44, a DC/DC converter (SDC) 47 that is a step-down converter, and a low voltage electrical power storage device (low voltage battery, LV BAT) 48 are included in the electrical power storage unit 43.

Among the loads of the electrical power storage unit 43 including the voltage conversion unit 42 and the high voltage electrical power storage device 44 connected to the fuel cell stack 18, there are included the motor 46 which serves as a main engine, the compressor 28 that is high voltage auxiliary equipment that is supplied with electrical power from the high voltage electrical power storage device 44, and low voltage auxiliary equipment other than the compressor 28 (for example, an air conditioner, the control device 15, various sensors, various solenoid valves, the injector 32, the coolant pump 38, and the like, each of which will be described later) that are supplied with electrical power from the low voltage electrical power storage device 48.

The DC/DC converter 40 performs a voltage boosting (step-up) conversion on the output voltage Vfc, which is a generated DC voltage from the fuel cell stack 18, and applies a high voltage that is used for driving to a DC terminal of the inverter 45 and to the DC/DC converter 41.

The DC/DC converter 41 performs a voltage decreasing (step-down) conversion from the high voltage used for driving to the battery voltage Vbh of the high voltage electrical power storage device 44, and charges the high voltage electrical power storage device 44.

The DC/DC converter 47 steps down the high voltage battery voltage Vbh to a low voltage battery voltage Vbl, and charges the low voltage electrical power storage device 48.

A high voltage obtained by step-up conversion of the battery voltage Vbh by the DC/DC converter 41, and/or a high voltage obtained by step-up conversion of the output voltage Vfc by the DC/DC converter 40, is applied to the DC terminal of the inverter 45.

The inverter 45 converts the high DC voltage into a three-phase AC voltage, and thereby drives the motor 46. The inverter 45 converts a regenerative voltage of the motor 46 into a high DC voltage. Such a high DC voltage is converted into a low voltage by the DC/DC converter 41, and is applied to the high voltage electrical power storage device 44, and thereby charges the high voltage electrical power storage device 44.

The fuel cell vehicle 12 travels due to a driving force generated by the motor 46.

In the fuel cell stack 18, a plurality of electrical power generation cells 50 are stacked. Each of the electrical power generation cells 50 is equipped with a membrane electrode assembly 52, and separators 53 and 54 that sandwich the membrane electrode assembly 52 therebetween.

The membrane electrode assembly 52 is equipped, for example, with a solid polymer electrolyte membrane 55 that is a thin film of perfluorosulfonic acid containing water, and a cathode 56 and an anode 57 that sandwich the solid polymer electrolyte membrane 55 therebetween.

The cathode 56 and the anode 57 include a gas diffusion layer (not shown) made of carbon paper or the like. By uniformly applying, on the surface of the gas diffusion layer, porous carbon particles on which a platinum alloy is supported, an electrode catalyst layer (not shown) is formed. The electrode catalyst layer is formed on both sides of the solid polymer electrolyte membrane 55.

On the surface of one separator 53 facing toward the membrane electrode assembly 52, a cathode flow path (oxygen containing gas flow path) 58 is formed along the cathode 56, connecting an oxygen containing gas inlet communication port 101 and an oxygen-containing off gas outlet communication port 102 with each other.

On the surface of another separator 54 facing toward the membrane electrode assembly 52, an anode flow path (fuel gas flow path) 59 is formed along the anode 57, connecting a fuel gas inlet communication port 103 and a fuel gas outlet communication port 104 with each other.

A voltage sensor 110 that detects the output voltage Vfc of the fuel cell stack 18 is provided between wirings connecting a positive terminal 108 and a negative terminal 106 and the DC/DC converter 40. Furthermore, an electrical current sensor 112 that detects a generated electrical current Ifc is provided to wirings connecting the positive terminal 108 and the DC/DC converter 40.

By the voltage sensor 110 and the electrical current sensor 112, an electrical power generation state acquisition unit 115 is formed that detects a generated electrical power as the electrical power generation state. The voltage sensor 110 may be provided for each of the electrical power generation cells 50, or alternatively, for each of groups of the electrical power generation cells 50.

The compressor 28 is constituted by a mechanical supercharger or the like. The mechanical supercharger is driven by a compressor motor (not shown) the rotation of which is controlled by a three-phase AC output of a compressor inverter (not shown) to which the high voltage battery voltage Vbh of the electrical power storage device 44 is applied.

The compressor 28 includes functions such as drawing in external air (the atmosphere, air) from an external air intake port 113, pressurizing the air, and supplying the pressurized air to the fuel cell stack 18 through the humidifier 30.

The humidifier 30 includes a flow path 31A and a flow path 31B. Air (an oxygen containing gas), which has been compressed by the compressor 28, heated to a high temperature, and dried, flows through the flow path 31A. The oxygen-containing off gas, which is a discharged gas that is discharged from the oxygen-containing off gas outlet communication port 102 of the fuel cell stack 18 via an oxygen-containing off gas outlet 92, flows through the flow path 31B.

The humidifier 30 has a function of humidifying the oxygen-containing gas supplied from the compressor 28. More specifically, the humidifier 30 causes moisture contained within the oxygen-containing off gas to move from the flow path 31B to, via an internal porous membrane, the supplied gas (the oxygen-containing gas) that flows through the flow path 31A, and thereby humidifies the supplied gas, and in addition, supplies the humidified oxygen-containing gas to the fuel cell stack 18 through an oxygen-containing gas inlet 91.

In an oxygen-containing gas supply flow path 62 (including oxygen-containing gas supply flow paths 62A and 62B) from the external air intake port 113 to the oxygen-containing gas inlet 91, an air flow sensor (AFS: air flow sensor) 116, the compressor 28, an inlet side sealing valve 118, and the humidifier 30 are provided in this order starting from the external air intake port 113. Moreover, it should be noted that the flow paths such as the oxygen-containing gas supply flow path 62 and the like, which are drawn with double lines, are formed by piping (the same feature applies hereinafter). Concerning the inlet side sealing valve 118, the degree to which the valve is opened can be variably controlled by the control device 15, and the inlet side sealing valve 118 opens and closes the oxygen-containing gas supply flow path 62.

In an oxygen-containing off gas discharge flow path 63 that communicates with the oxygen-containing off gas outlet 92, there are provided the humidifier 30 and an outlet side sealing valve 120 in this order from the oxygen-containing off gas outlet 92, the outlet side sealing valve 120 also functioning as a back pressure valve. Concerning the outlet side sealing valve 120, the degree to which the valve is opened can be variably controlled by the control device 15, and the outlet side sealing valve 120 opens and closes the oxygen-containing off gas discharge flow path 63.

A bypass flow path 66, which places the oxygen-containing gas supply flow path 62 in communication with the oxygen-containing off gas discharge flow path 63, is provided between a suction port of the inlet side sealing valve 118 and a discharge port of the outlet side sealing valve 120. A bypass valve 122 that opens and closes the bypass flow path 66 is provided in the bypass flow path 66.

The degree to which the bypass valve 122 is opened can be variably controlled by the control device 15. The bypass valve 122 adjusts the flow rate of the oxygen-containing gas that bypasses the fuel cell stack 18.

A merging flow path between the bypass flow path 66 and the oxygen-containing off gas discharge flow path 63 communicates with a discharge flow path 64.

The fuel tank 20 is equipped with an electromagnetically operated hydrogen shutoff valve 21, and serves as a container in which high purity hydrogen is compressed at a high pressure and accommodated therein.

The fuel gas (hydrogen) discharged from the fuel tank 20 passes through the injector 32 and the ejector 34 that are provided in a fuel gas supply flow path 72, and is supplied to an inlet of the anode flow path 59 via a fuel gas inlet 93 and a fuel gas inlet communication port 103 of the fuel cell stack 18.

In this case, in the fuel gas supply flow path 72, a pressure sensor 73 is provided that detects (measures) a gas pressure (anode pressure) Pa of the fuel gas in the fuel gas supply flow path 72.

An outlet of the anode flow path 59 is in communication with an inlet 151 of the gas-liquid separation device 36 through the fuel gas outlet communication port 104, a fuel off gas outlet 94, and a fuel off gas discharge flow path 74, and further, the fuel off gas, which is a hydrogen containing gas, is supplied to the gas-liquid separation device 36 from the anode flow path 59.

In actuality, a portion of the water generated by the electrical power generation of the fuel cell stack 18 moves from the cathode flow path 58 to the anode flow path 59 by way of reverse-diffusion (permeation) through the membrane electrode assembly 52.

In the case that this reversely diffused water cannot be properly drained from the fuel off gas discharge flow path 74, or alternatively, from a circulation flow path 77, the water may ingress into the anode 57 of the fuel cell stack 18 and disadvantageously block the anode flow path (the fuel gas flow path) 59, thereby bringing about a deterioration in the electrical power generation stability of the fuel cell stack 18.

In order to prevent such an inconvenience, the gas-liquid separation device 36, which temporarily stores the water, separates the fuel off gas into a gas component and a liquid component (liquid water).

The gas component (the fuel off gas) of the fuel off gas is discharged from a gas discharge port 152 of the gas-liquid separation device 36, passes through the circulation flow path 77, and is supplied to a suction port of the ejector 34.

The liquid component (liquid water) of the fuel off gas, which is made up from reversely diffused water, passes from a liquid discharge port 160 of the gas-liquid separation device 36 and through a drain flow path 162 in which a drain valve 164 is provided, is mixed with the discharged gas that is discharged from the discharge flow path 64, and is discharged into the external air through a discharge flow path 99 and a discharge gas exhaust port 168.

A portion of the fuel off gas (a hydrogen containing gas) is discharged into the drain flow path 162 together with the liquid water. Further, after discharging of the liquid water is completed, a situation is brought about in which only the fuel off gas (the hydrogen containing gas) is discharged into the drain flow path 162.

In order to dilute the hydrogen gas within the fuel off gas and discharge the fuel off gas to the exterior, a portion of the oxygen-containing gas discharged from the compressor 28 passes through the bypass flow path 66, and is supplied to the discharge flow path 64.

In the case that the drain valve 164 continues to be opened even after the water has drained from the drain flow path 162, hydrogen will be thrown away and wasted. Thus, after the water has been drain from the gas-liquid separation device 36, it is necessary to appropriately close the drain valve 164.

The oxygen-containing gas that has passed through the bypass flow path 66 is mixed with the oxygen-containing off gas (including a remaining part of the fuel off gas that did not undergo the reaction) that flows through the oxygen-containing off gas discharge flow path 63, and then flows through the discharge flow path 64.

The discharge flow path 64 communicates and merges with the drain flow path 162, and communicates with the discharge flow path 99.

In the discharge flow path 99, due to the oxygen-containing off gas from the discharge flow path 64, the fuel gas within the mixed fluid of the liquid water and the fuel off gas discharged from the drain flow path 162 is diluted, passes through the discharge gas exhaust port 168, and is discharged to the exterior (into the atmosphere) of the fuel cell vehicle 12.

The coolant supply device 26 of the fuel cell system 10 includes a coolant flow path 138 through which a refrigerant (coolant) serving as a heat medium flows. The coolant flow path 138 includes a coolant supply flow path 140 and a coolant discharge flow path 142. The coolant supply flow path 140 supplies the coolant to a coolant flow path 60 of the fuel cell stack 18, and the coolant discharge flow path 142 discharges the coolant from the coolant flow path 60 of the fuel cell stack 18. The radiator 39 is connected to the coolant supply flow path 140 and the coolant discharge flow path 142.

The radiator 39 serves to cool the coolant. The coolant pump 38 is disposed in the coolant supply flow path 140. The coolant pump 38 causes the coolant to circulate inside a coolant circulation circuit. The coolant supply flow path 140, an internal coolant flow path of the fuel cell stack 18, the coolant discharge flow path 142, and the radiator 39 are included in the coolant circulation circuit. A temperature sensor 76 is provided in the coolant discharge flow path 142. The temperature (coolant outlet temperature) of a cooling medium detected by the temperature sensor 76 is detected (measured) as the (internal) temperature of the fuel cell stack 18.

The respective constituent elements of the above-described fuel cell system 10 are controlled as a whole by the control device 15.

Moreover, it should be noted that, although the inlet side sealing valve 118, the outlet side sealing valve 120, and the drain valve 164 are flow rate adjustment valves the valve openings of which are controlled by the control device 15, the duty thereof may also be controlled using electromagnetic control type ON/OFF valves.

The control device 15 is constituted by an ECU (Electronic Control Unit). The ECU is composed of a computer having at least one processor (CPU), a memory, an input/output interface, and an electronic circuit. The at least one processor (CPU) executes a non-illustrated program (computer-executable instructions) that is stored in a memory.

The processor of the control device 15, by executing calculations in accordance with the program, controls operations of the fuel cell vehicle 12 and the fuel cell system 10.

An electrical power source switch (electrical power source SW) 71 of the fuel cell vehicle 12 is connected to the control device 15. The electrical power source switch 71 is operated by a user, and thereby causes an electrical power generation driving operation of the fuel cell stack 18 of the fuel cell system 10 to be started or continued (ON), or to be ended (OFF). Also connected to the control device 15 are an accelerator opening sensor, a vehicle speed sensor, and an SOC sensor of the electrical power storage device 44, none of which are illustrated. The electrical power source SW 71, by using a timer 70, is capable of performing a so-called RTC startup (automatic ON and OFF) of the fuel cell system 10.

### [Operations]

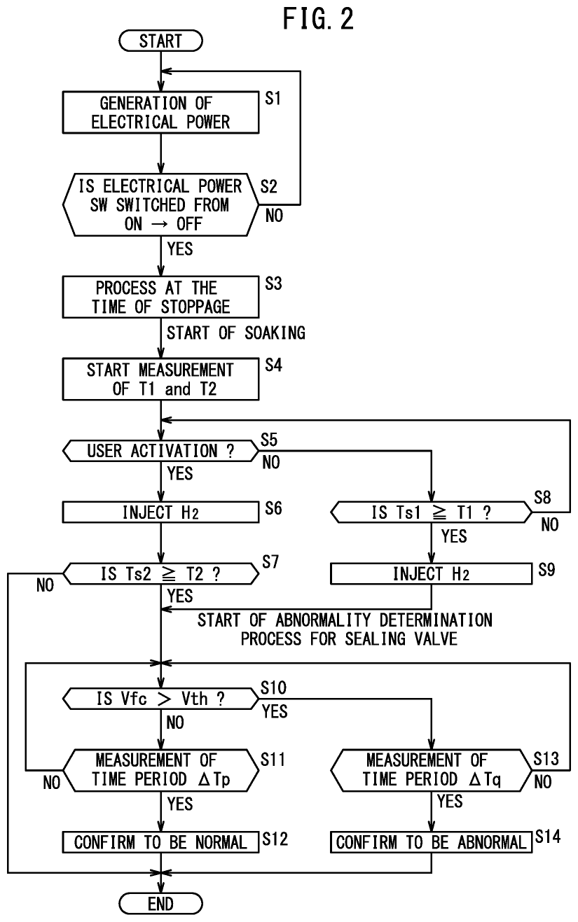

The fuel cell system 10 according to the present embodiment is basically configured in the manner described above. Hereinafter, with reference to the flowchart of FIG. 2, a description will be given concerning operations of the fuel cell system 10 in relation to the detection and determination of a malfunction (malfunction of the valves) in the sealing function of the inlet side sealing valve 118 and the outlet side sealing valve 120.

For the sake of brevity and to facilitate understanding, the process according to the flowchart shown in FIG. 2 is initiated from a state in which the fuel cell stack 18 is generating electrical power at a time when the fuel cell vehicle 12 is running or at a time when the fuel cell vehicle 12 is stopped and idling.

During the generation of electrical power in step S1, in the fuel gas supply device 24, the fuel gas from the fuel tank 20 passes through the shutoff valve 21 and is discharged via the injector 32 into a drive port nozzle of the ejector 34. Moreover, it should be noted that the injector 32, due to being controlled by the control device 15, is driven, for example, under a PWM control, whereby the amount of the fuel gas that is discharged can be adjusted. As is well known, driving under a PWM control is an electrical power control method in which a constant period of ON and OFF of a pulse train is created, and a time width (ON duty) thereof is caused to be changed.

The fuel gas passes from the drive port nozzle of the ejector 34 and through the diffuser of the ejector 34, and is introduced into the anode flow path 59 via the fuel gas inlet 93 and the fuel gas inlet communication port 103.

By the fuel gas moving along the anode flow path 59, the fuel gas is supplied to the anode 57 of the membrane electrode assembly 52.

In the oxygen-containing gas supply device 22, the external air is increased in pressure and compressed by the compressor 28, and the oxygen-containing gas that has been raised in temperature is supplied to the oxygen-containing gas inlet 91 via the inlet side sealing valve 118 and the humidifier 30.

The oxygen-containing gas is introduced into the cathode flow path 58 via the oxygen-containing gas inlet 91 and the oxygen-containing gas inlet communication port 101.

By the oxygen-containing gas moving along the cathode flow path 58, the oxygen-containing gas is supplied to the cathode 56 of the membrane electrode assembly 52.

In each of the membrane electrode assemblies 52, the fuel gas supplied to the anode 57, and the oxygen within the oxygen-containing gas supplied to the cathode 56 are consumed by an electrochemical reaction inside the electrode catalyst layer, and thereby the generation of electrical power is carried out.

At the anode 57, by the fuel gas (hydrogen) being supplied, hydrogen ions are generated from hydrogen molecules due to an electrode reaction by the catalyst, and the hydrogen ions pass through the solid polymer electrolyte membrane 55 and move to the cathode 56, while on the other hand, electrons are released from the hydrogen molecules.

The electrons that are released from the hydrogen molecules pass through from the negative terminal 106 to the motor 46 via the DC/DC converter 40 and the inverter 45, and move to the cathode 56 via the positive terminal 108. The electrons, in addition to passing through the motor 46, which serves as the main engine, and moving to the cathode 56, also pass through various auxiliary devices and move to the cathode 56.

At the cathode 56, due to the action of the catalyst, the hydrogen ions and the electrons react with the oxygen contained in the supplied oxygen-containing gas, and thereby water is generated.

The water that is generated (generated water) permeates through the solid polymer electrolyte membrane 55 and also reaches the anode 57. Therefore, the generated water is generated inside the fuel cell stack 18.

In the coolant supply device 26, under the operation of the coolant pump 38, the coolant is supplied from the coolant supply flow path 140 to the coolant flow path 60 of the fuel cell stack 18. The coolant flows along the coolant flow path 60 and cools the electrical power generation cells 50, and thereafter, the coolant is discharged into the coolant discharge flow path 142.

The fuel gas, which is supplied to the anode 57 and is partially consumed, is discharged as a fuel off gas into the fuel off gas discharge flow path 74 from the fuel gas outlet communication port 104 and the fuel off gas outlet 94. The fuel off gas is introduced from the fuel off gas discharge flow path 74 into the suction port of the ejector 34 via the gas-liquid separation device 36 and the circulation flow path 77.

The fuel off gas that was introduced from the suction port is drawn inside the ejector 34 due to an action of the negative pressure generated by the fuel gas introduced from the drive port nozzle, is mixed with the fuel gas, and is released from the discharge port of the ejector 34 into the fuel gas supply flow path 72.

The fuel gas, which is mixed with the fuel off gas that was discharged into the fuel gas supply flow path 72, flows into the anode flow path 59 inside the fuel cell stack 18 via the fuel gas inlet 93 and the fuel gas inlet communication port 103.

The fuel off gas, which was discharged into the fuel off gas discharge flow path 74, is, as needed, discharged (purged) to the exterior under an opening action of the drain valve 164. Similarly, the oxygen-containing gas, which was supplied to the cathode 56 and partially consumed, passes through the oxygen-containing off gas outlet communication port 102 and the oxygen-containing off gas outlet 92, and is discharged as an oxygen-containing off gas into the oxygen-containing off gas discharge flow path 63.

The oxygen-containing off gas that is discharged into the oxygen-containing off gas discharge flow path 63 passes through the discharge flow path 64 via the humidifier 30 and the outlet side sealing valve 120, the discharge flow path 99, and the discharge gas exhaust port 168, and is discharged to the exterior (into the outside air, the atmosphere).

In step S2, it is determined whether or not the electrical power source switch 71 has transitioned from being in an ON state to an OFF state. In the case of not having transitioned to the OFF state (step S1: NO), the electrical power generation process of step S1 is continued, and in the case that the state has changed to the OFF state (step S1: YES), the process advances to step S3.

In step S3, the control device 15 carries out the process at the time of stoppage (at-the-time-of-stoppage process).

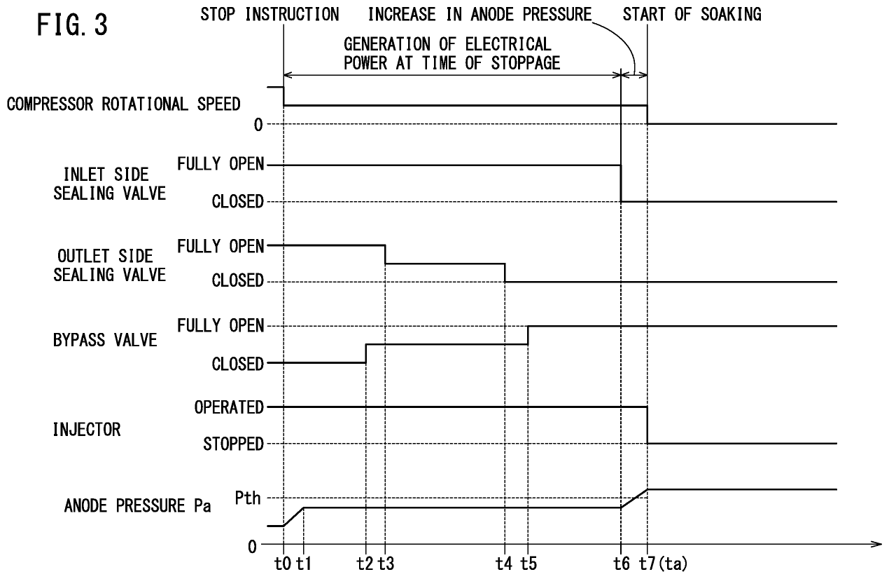

FIG. 3 is a timing chart illustrating an example of a process at the time of stoppage.

At the point in time to in FIG. 3, when the control device 15 has detected a stop instruction from the user by which the electrical power source switch 71 transitions from the ON state to the OFF state (corresponding to the determination of YES in step S2), the control device 15 causes the ON duty of the injector 32 to increase up to the point in time t1, and thereby causes the anode pressure Pa to increase. The anode pressure Pa is detected by the pressure sensor 73, and is acquired by the control device 15.

On the other hand, at the point in time to, the control device 15 causes the rotational speed of the compressor 28 to decrease, and allows the rotation thereof to continue (the supply of the oxygen-containing gas is continued).

At the point in time t2, the bypass valve 122 is switched from being in a closed state to a partially open state (a predetermined state of opening between a closed state and a fully open state), and at the point in time t3, the outlet side sealing valve 120 is switched from being in a fully open state to a partially open state.

Between the point in time t3 and the point in time t4, the operating state of the injector 32, the low rotational speed state of the compressor 28, the fully open state of the inlet side sealing valve 118, the partially open state of the bypass valve 122, and the partially open state of the outlet side sealing valve 120 are continued.

At the point in time t4, the outlet side sealing valve 120 is switched from being in a partially open state to a closed state. At the point in time t5, the bypass valve 122 is switched to a fully open state. At the point in time t6, the inlet side sealing valve 118 is switched from being in a fully open state to a closed state.

Between the point in time to and the point in time t6, the so-called electrical power generation process at the time of stoppage (at-the-time-of-stoppage electrical power generation process) is continued, and the oxygen inside the cathode flow path 58 is consumed, and as a result, the interior of the cathode flow path 58 is filled with an oxygen-containing gas which is rich in nitrogen N₂.

Moreover, surplus electrical power, which is generated by the fuel cell system 10 during the electrical power generation process at the time of stoppage, passes through the DC/DC converter 40 and the DC/DC converter 41 and is used to charge the electrical power storage device 44.

From the point in time t6 after the generation of electrical power at the time of stoppage until the point in time t7 (which will be described later as a point in time ta), the control device 15 causes the ON duty of the injector 32 to increase again, and thereby increases the anode pressure Pa inside the anode flow path 59 to become greater than or equal to a predetermined threshold pressure value Pth.

In a state of having become Pa≥Pth, at the point in time t7 (the point in time ta), the control device 15 stops the operation of the injector 32 and the compressor 28.

At the point in time t7, in the fuel cell system 10 (the fuel cell vehicle 12), soaking is initiated. In a state of soaking after the point in time t7, the inlet side sealing valve 118 and the outlet side sealing valve 120 continue to be in the closed state, and the bypass valve 122 is maintained in the fully open state. Further, the shutoff valve 21 and the drain valve 164 are maintained in the closed state.

In such a state of soaking, the fuel gas (hydrogen H₂) gradually permeates (diffuses) via the membrane electrode assembly 52 from the anode flow path 59 to the cathode flow path 58.

Returning to the flowchart of FIG. 2, from the time when the system is stopped at the point in time t7 (ta) after the process at the time of stoppage of step S3, then in step S4, the control device 15 starts measurement of a first threshold time period T1 and a second threshold time T2 period by the timer 70, whereupon the process advances to step S5. Moreover, it should be noted that the time period measured by the timer 70 until the first threshold time period T1 is set as a soaking time period Ts=Ts1, and the time period measured by the timer 70 until the second threshold time period T2 is set as a soaking time period Ts=Ts2.

In this instance, the second threshold time period T2 can be arbitrarily set to a time period that is shorter than the first threshold time period T1 (T2<T1). Further, the first threshold time period T1 needs only to be set to a time period that is longer than the second threshold time period T2 (T1>T2), and can be arbitrarily set in accordance with the second threshold time period T2.

In step S5, the control device 15 determines whether or not the electrical power source switch 71 has been made to transition by the user (i.e., has been activated by the user) from the OFF state to the ON state.

When the control device 15 has detected that the electrical power source switch 71 has transitioned from the OFF state to the ON state (user activation) (step S5: YES), the process advances to step S6, and when such a transition is not detected (step S5: NO), the process advances to S8.

In step S6, the control device 15 opens the shutoff valve 21, drives the injector 32, and injects the fuel gas (H2) from the fuel tank 20 into the fuel cell stack 18, whereupon the process advances to step S7. Moreover, the injection of the fuel gas in step S6 by the control device 15 is carried out while the inlet side sealing valve 118 and the outlet side sealing valve 120 are maintained in a fully closed state.

In step S7, the control device 15 determines whether or not the soaking time period Ts2 at the point in time of the user activation in step S5 is greater than or equal to the second threshold time period T2, and at the time when Ts2 has become greater than or equal to T2 (Ts2≥T2) (step S7: YES), then in order to carry out the abnormality determination process (malfunction detection process, malfunction determination process) for the inlet side sealing valve 118 and the outlet side sealing valve 120, the process advances to step S10.

In step S7, in the case that the soaking time period Ts2 at the time of user activation performed in step S5 is less than the second threshold time period T2 (Ts2<T2) (step S7: NO), the control device 15 brings the process to an end without performing the abnormality determination process.

On the other hand, when activation by the user is not detected (step S5: NO), then in step S8, the control device 15 determines whether or not the soaking time period Ts1 is greater than or equal to the first threshold time period T1, and while the determination of step S8: NO→Step S5: NO continues, at the time when Ts1≥T1 (step S8: YES), the process advances to step S9.

In step S9, in the same manner as in the (H₂) injection process of step S6, while performing control to maintain the inlet side sealing valve 118 and the outlet side sealing valve 120 in the fully closed state, the control device 15 opens the shutoff valve 21, and drives the injector 32. Consequently, the fuel gas (H₂) is introduced from the fuel tank 20 into the fuel cell stack 18 (automatic hydrogen injection process).

After the fuel gas (H₂) has been injected into the fuel cell stack 18, then in order to carry out the abnormality determination process for the inlet side sealing valve 118 and the outlet side sealing valve 120, the control device 15 advances the process to step S10.

In the abnormality determination process of step S10, the control device 15 determines whether or not the output voltage Vfc detected by the voltage sensor 110 is a voltage in excess of the predetermined threshold voltage value Vth (Vfc>Vth).

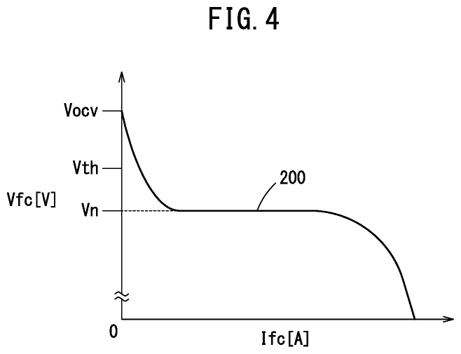

Moreover, it should be noted that the threshold voltage Vth, as shown in FIG. 4, is set beforehand to a voltage between a normal electrical power generation voltage Vn and an open circuit voltage Vocv on the current/voltage characteristic 200 of the fuel cell stack 18.

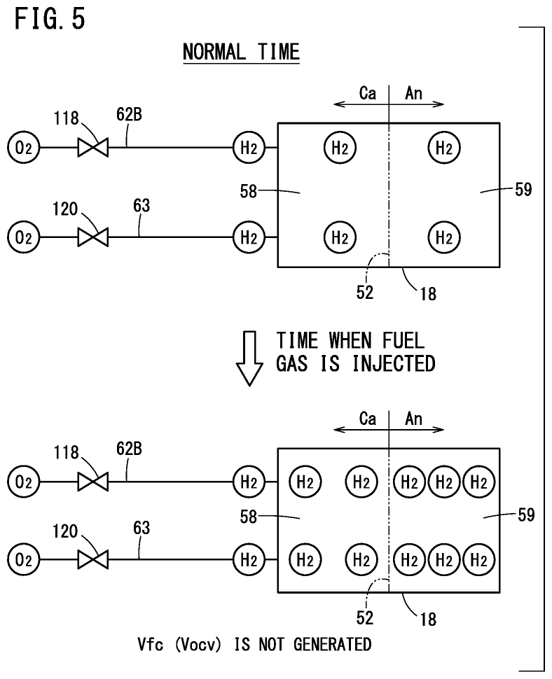

FIG. 5 is a schematic explanatory view of a case in which, in the case that the soaking time period Ts is longer than the second threshold time period T2 (Ts≥T2<T1), both the inlet side sealing valve 118 and the outlet side sealing valve 120 are determined to be normal (in the closed state) (the sealing function thereof is normal).

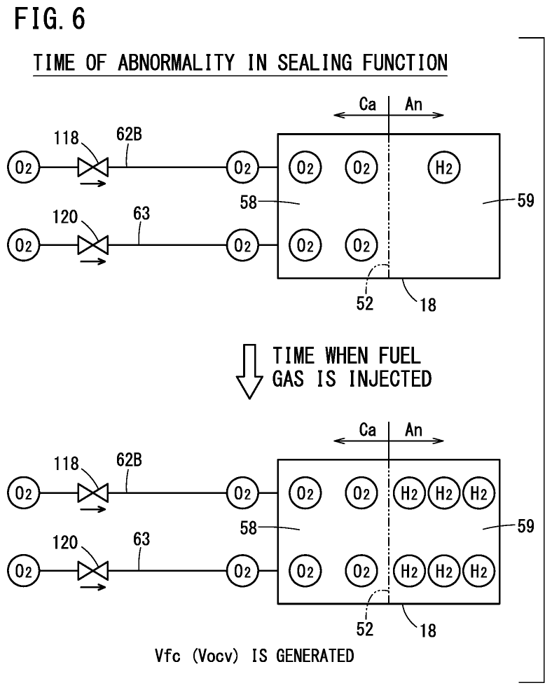

FIG. 6 is a schematic explanatory view of a case in which, in the case that the soaking time period Ts is longer than the second threshold time period T2 (Ts≥T2<T1), the inlet side sealing valve 118 or the outlet side sealing valve 120 is determined to be abnormal (the sealing function thereof is abnormal).

As shown in the upper diagram of FIG. 5, in the case that the soaking time period Ts has elapsed past the second threshold time period T2 and the inlet side sealing valve 118 and the outlet side sealing valve 120 are in a normally sealed state (a closed state), the hydrogen H₂ that has permeated from the anode flow path 59 through the membrane electrode assembly 52 enters into the cathode flow path 58 of the fuel cell stack 18.

In this state, as shown in the lower diagram of FIG. 5, due to the user activation (step S5: YES) or the automatic hydrogen injection process (step S8: YES), even if the hydrogen H₂ is injected into the anode flow path 59 of the fuel cell stack 18, since hydrogen H₂ is present in both the cathode flow path 58 and the anode flow path 59, an electrochemical reaction does not occur between the hydrogen H₂ and the oxygen O₂. In other words, the fuel cell stack 18 is incapable of generating the output voltage Vfc, which is an electromotive force (Vfc=0[V]).

The output voltage Vfc=0 is detected by the voltage sensor 110, and is acquired by the control device 15.

In this case, since the output voltage Vfc is Vfc=0, the control device 15 makes a negative determination in step S10 (step S10: NO).

In step S11, when this negative determination time period measured by the timer 70 is a predetermined minute time period ΔTp, then in step S12, the control device 15 confirms that the inlet side sealing valve 118 and the outlet side sealing valve 120 are normal, and the process comes to an end.

On the other hand, as shown in the upper diagram of FIG. 6, in the case that the inlet side sealing valve 118 or the outlet side sealing valve 120 is in a malfunctioning state of being in an open state (any state in which the valve is slightly open to fully open), for example, even in a malfunctioning state of being slightly open, since the soaking time period Ts which is greater than or equal to the second threshold time period T2 (T1>T2) has elapsed, a state is brought about in which O₂ has entered into the cathode flow path 58.

In this state, as shown in the lower diagram of FIG. 6, due to the user activation (step S5: YES) or the automatic hydrogen injection process (step S8: YES), in the case that the hydrogen H₂ is introduced into the anode flow path 59 of the fuel cell stack 18, since the oxygen O₂ is present in the cathode flow path 58 and the hydrogen H₂ is present in the anode flow path 59, the fuel cell stack 18 generates the open circuit voltage Vocv (Vfc=Vocv>Vth) which is an electromotive force for a case in which the generated electrical current Ifc is not drawn (a load is not connected; thus Ifc=0).

The output voltage Vfc=Vocv is detected by the voltage sensor 110, and is acquired by the control device 15.

In this case, since the output voltage Vfc satisfies the condition of Vfc=Vocv≥Vth, the control device 15 makes an affirmative determination in step S10 (step S10: YES).

In step S13, when the affirmative determination time period measured by the timer 70 is a predetermined time period ΔTq measured by the timer 70, then in step S14, the control device 15 confirms that the inlet side sealing valve 118 or the outlet side sealing valve 120 is abnormal.

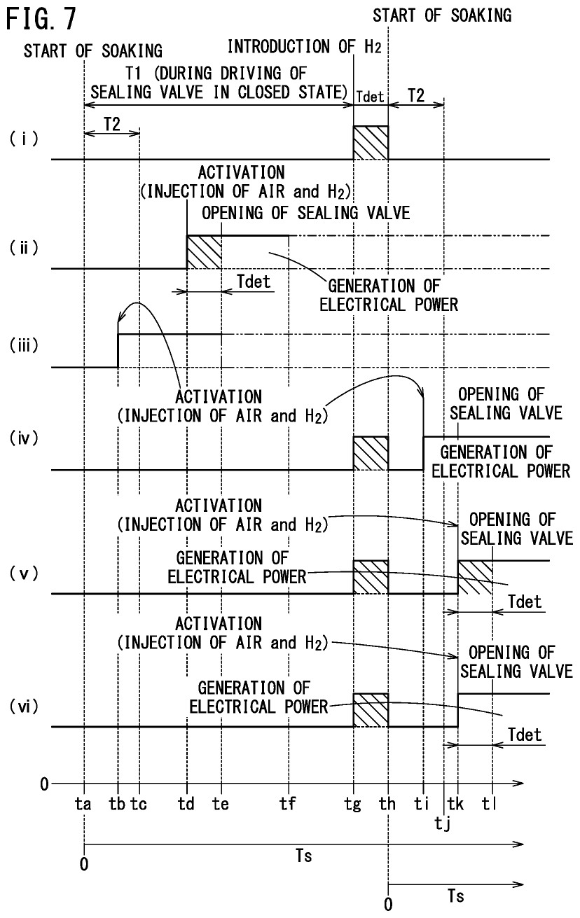

FIG. 7 shows, as an exemplary operation, a time chart which is provided to describe, for example, the determination process of step S7 and step S8 at the time when the control device 15 detects the introduction of hydrogen H₂ during the soaking time period Ts from the point in time ta (refer to the point in time t7 in FIG. 3) when the soaking state is started while the system is stopped.

In the exemplary operation (i) shown in FIG. 7, the hydrogen H₂ is automatically introduced from the fuel tank 20 through the injector 32 during a detection process time period Tdet, which is from the point in time tg when the first threshold time period T1 has elapsed after the soaking state is started until the point in time th, and thereafter, the injector 32 is stopped. Consequently, the hydrogen H₂ is sealed in the anode flow path 59 of the fuel cell stack 18, and the anode pressure Pa is increased.

In the case of the exemplary operation (i), the control device 15 executes the abnormality determination process of step S10 in accordance with the result of the automatic increase in pressure itself (step S9).

Moreover, in FIG. 7, execution of the abnormality determination process is indicated by the hatched sections.

In the exemplary operation (ii) shown in FIG. 7, at the point in time td that comes after the point in time tc that is after the second threshold time period T2 has elapsed after the soaking state is started, the system is activated by the user by an operation of placing the electrical power source switch 71 in the ON state, and the hydrogen H₂ is introduced prior to the point in time the when the generation of electrical power is started (opening of the inlet side sealing valve 118 and the outlet side sealing valve 120). Consequently, the hydrogen H₂ is sealed in the anode flow path 59 of the fuel cell stack 18, and the anode pressure Pa is increased. Thereafter, the oxygen-containing gas is supplied into the fuel cell stack 18, and the generation of electrical power is started.

In the case of the exemplary operation (ii), the control device 15 executes the abnormality determination process of step S10 in accordance with the determination result of step S7: YES.

In the exemplary operation (iii) in FIG. 7, at the point in time tb prior to the elapse of the second threshold time period T2 after the soaking state is started, the electrical power source switch 71 is manually turned ON by the user, and the oxygen-containing gas is introduced, and together therewith, the hydrogen H₂ is also introduced.

In the case of the exemplary operation (iii), the control device 15 brings the process to an end without executing the abnormality determination process of step S10.

In the exemplary operation (iv) shown in FIG. 7, the hydrogen He is automatically introduced from the fuel tank 20 through the injector 32 during the detection process time period Tdet, which is from the point in time tg when the first threshold time period T1 has elapsed after the soaking state is started until the point in time th, and thereafter, the injector 32 is stopped. Consequently, the hydrogen He is sealed in the anode flow path 59 of the fuel cell stack 18, and the anode pressure Pa is increased.

Thereafter, at the point in time ti, the system is activated by the user by an operation of placing the electrical power source switch 71 in the ON state, and the hydrogen He is introduced prior to starting the generation of electrical power at the point in time tk (opening of the inlet side sealing valve 118 and the outlet side sealing valve 120).

Consequently, the hydrogen He is sealed in the anode flow path 59 of the fuel cell stack 18, and the anode pressure Pa is increased. Thereafter, the oxygen-containing gas is supplied into the fuel cell stack 18, and the generation of electrical power is started.

In the case of the exemplary operation (iv), the control device 15 executes the abnormality determination process until the point in time th. Further, at the time of user activation at the point in time ti, since the second threshold time period T2 has not elapsed from the point in time th when soaking is started, the process comes to an end without executing the abnormality determination process, and from the point in time tk and thereafter, the generation of electrical power is started.

In the case of the exemplary operation (v) in FIG. 7, at the time when the anode pressure Pa is increased from the point in time tg to the point in time th, for the same reason as in the exemplary operation (iv), the abnormality determination process of step S10 is executed. Furthermore, also at the time of user activation at the point in time tk after the soaking time period Ts (Ts=(tk−th)≥T2) has elapsed, the abnormality determination process is executed between the point in time tk and the point in time t1.

In the case of the exemplary operation (vi) in FIG. 7, at the time when the anode pressure Pa is increased from the point in time tg to the point in time th, for the same reason as in the exemplary operation (iv), the abnormality determination process of step S10 is executed.

In the abnormality determination process of step S10 (in this case, between the point in time tg and the point in time th), in the case that at least one of the inlet side sealing valve 118 and the outlet side sealing valve 120 is determined to be abnormal (in a valve open state in which the sealing state is abnormal), the abnormality determination process of step S10 is not carried out at the time of user activation at the point in time tk after the soaking time period Ts (Ts=(tk−th)≥T2) has elapsed. Since it has already been determined that there is an abnormality between the point in time tg and the point in time th, it is possible to make a more accurate determination by making the determination again after having driven the inlet side sealing valve 118 or the outlet side sealing valve 120 again.

In this manner, in the case of the exemplary operation (vi) in which an abnormality is detected between the point in time tg and the point in time th, the abnormality determination process is not carried out between the point in time tk and the point in time tl. In the case of the exemplary operation (vi), at the point in time tl, both the inlet side sealing valve 118 and the outlet side sealing valve 120 are driven to be placed in a fully open state, and the generation of electrical power in the fuel cell stack 18 is started.

At the point in time tl in exemplary operation (vi), the control device 15 drives the inlet side sealing valve 118 and the outlet side sealing valve 120 to be opened one time, and after the fuel cell stack 18 has started the generation of electrical power, as was described with reference to FIG. 3, the electrical power generation process at the time of stoppage is performed by transitioning the electrical power source switch 71 to the OFF state, and the soaking state is started at the point in time t7 (the point in time ta).

In this case, after having determined that there is an abnormality between the point in time tg and the point in time th in the exemplary operation (vi), the abnormality determination process is carried out again between the point in time tg and the point in time th in the exemplary operation (i), or alternatively, between the point in time td and the point in time te in the exemplary operation (ii).

In the determination process of such an abnormal state, in the case that the abnormal state is determined a plurality of times (exemplary operation (vi) and exemplary operation (i) or exemplary operation (vi) and exemplary operation (ii)) in a row with the driving of the valves interposed therebetween, the control device 15 determines that there is a malfunction in at least one of the inlet side sealing valve 118 and the outlet side sealing valve 120.

In this manner, it is possible to avoid a situation in which the abnormality determination process is executed continuously in the same driving state of the inlet side sealing valve 118 and the outlet side sealing valve 120. More specifically, in the case of the exemplary operation (vi), in a state in which the sealing function of at least one of the inlet side sealing valve 118 and the outlet side sealing valve 120 is in an abnormal state, an erroneous determination made by carrying out a continuous abnormality determination process without performing driving of the valves can be prevented.

In the abnormality determination process, after having determined that there is an abnormal state, only after at least either one of the inlet side sealing valve 118 and the outlet side sealing valve 120 is driven to be placed in an open state, the detection of the abnormality in step S10 and thereafter may be repeatedly carried out.

### Exemplary Modification

The above-described embodiment can also be modified in the following manner.

In FIG. 1, a temperature sensor (air temperature sensor) is provided at the external air intake port 113. In the exemplary operation (i) shown in FIG. 7, after the point in time Ta when soaking is started, at a time when the outside temperature comes into close proximity to the freezing point, the control device 15 carries out detection of the outside temperature at a predetermined time interval using the temperature sensor.

When the outside air temperature has reached the freezing point, the fuel cell system 10 is automatically started and carries out a dry electrical power generation process for a certain time period, in order to cause the fuel cell stack 18 and the cathode flow path 58 and the anode flow path 59 of the fuel cell stack 18, as well as the flow paths that communicate with the cathode flow path 58 and the anode flow path 59 to be dried.

At the time of such an automatic starting and dry electrical power generation process, if the soaking time period (continuation time period) from the point in time Ta when soaking is started is in excess of the second threshold time period T2, the sealing valve abnormality determination process of step S10 may be executed.

[Inventions that can be Grasped from the Embodiment]

A description will be given below concerning the inventions that are capable of being grasped from the above-described embodiment and the exemplary modification thereof. Moreover, although to facilitate understanding, some of the constituent elements are designated by the reference numerals used in the above-described embodiment, the constituent elements are not limited to those elements to which such reference numerals are applied.

(1) The fuel cell system 10 according to the present invention is the fuel cell system that generates electrical power by way of an electrochemical reaction taking place between the oxygen-containing gas passing through the inlet side sealing valve 118 from the air compressor 28 and being supplied to the cathode flow path 58 along the cathode 56 of the fuel cell (50 or 18), and the fuel gas supplied from the fuel tank 20 to the anode flow path 59 along the anode 57 of the fuel cell, wherein the oxygen-containing off gas after the generation of electrical power passes through the outlet side sealing valve 120 and flows to the exterior, the fuel cell system including the voltage sensor 110 configured to detect the output voltage between the anode and the cathode, and at least one processor configured to execute computer-executable instructions stored in a memory, wherein the at least one processor executing the computer-executable instructions causes the fuel cell system to continue to generate electrical power at a time when the system is stopped, and after having consumed the oxygen-containing gas remaining from an outlet side of the inlet side sealing valve to an inlet side of the outlet side sealing valve, and together with driving the inlet side sealing valve and the outlet side sealing valve to place them in a closed state, carry out the electrical power generation process at the time of stoppage in which the supply of the fuel gas from the fuel tank to the anode flow path is suspended, and determine that the inlet side sealing valve or the outlet side sealing valve is in an abnormal state of being in an open state when the output voltage is detected by the voltage sensor and the detected output voltage is greater than or equal to a threshold voltage value, in the case that the fuel gas is newly supplied to the anode flow path after having completed the electrical power generation process at the time of stoppage, in a state in which the inlet side sealing valve and the outlet side sealing valve are driven and placed in the closed state.

At the time when the system is stopped, the generation of electrical power continues to be performed, and the electrical power generation process at the time of stoppage is carried out in which the oxygen containing gas within the cathode flow path is caused to be consumed together with causing the fuel gas to be retained in the anode flow path, and at a time of soaking after the electrical power generation process at the time of stoppage, the fuel gas is diffused from the anode flow path into the cathode flow path through a membrane electrode assembly.

Consequently, in a state in which the inlet side sealing valve and the outlet side sealing valve are driven and placed in the closed state, at the time when the fuel gas is newly supplied to the anode flow path, a determination is made as to whether or not the output voltage detected by the voltage sensor has exceeded the threshold voltage value. By means of such a determination result, even at a time when a minute leakage occurs, it is possible to reliably detect whether or not an abnormality has occurred in the inlet side sealing valve or the outlet side sealing valve. In turn, the present invention contributes to energy efficiency.

(2) Further, in the fuel cell system, the pressure sensor 73 configured to detect the fuel gas pressure is provided in the anode flow path, and at a time when the fuel gas pressure detected by the pressure sensor is increased up to the threshold gas pressure value, the processor causes the fuel cell system to stops the supply of the fuel gas, and to end the electrical power generation process at the time of stoppage.

In the foregoing manner, at the time of the electrical power generation process at the time of stoppage, the supply of the fuel gas is continued, and at the time the fuel gas pressure has increased up to the threshold gas pressure value, the supply of the fuel gas is stopped, whereby it is possible to reliably cause the oxygen containing gas in the cathode flow path to be consumed. As a result, it is possible to accurately detect whether or not the inlet side sealing valve and the outlet side sealing valve are abnormal at the next time that the fuel gas is supplied.

(3) Further, the fuel cell system includes the timer, wherein the processor causes the fuel cell system to determine that a time when the fuel gas is newly supplied to the anode flow path after the electrical power generation process at the time of stoppage is carried out is a time of user activation in which the fuel cell system after stoppage of the system in which the inlet side sealing valve and the outlet side sealing valve are driven and placed in the closed state is activated by the user, or alternatively, is a time when the anode pressure is automatically increased by the timer.

In accordance with this feature, at the time when the fuel cell system is started by the user or is automatically started by the timer, it is possible to detect whether or not the inlet side sealing valve and the outlet side sealing valve are abnormal.

(4) Further still, the processor causes the fuel cell system to, to perform a determination process of the abnormal state in the case that the anode pressure is automatically increased by the timer after a first threshold time period has elapsed from the time when the system is stopped or a time when soaking is started, and also perform the determination process of the abnormal state in the case that the user activation is carried out after a second threshold time period which is shorter than the first threshold time period has elapsed from the time when the system is stopped or the time when soaking is started.

In accordance with such a configuration, for example, in the case that the determination process of the abnormal state is carried out after the first threshold value time period, and thereafter user activation is carried out prior to the elapse of the second threshold value time period, which is shorter than the first threshold value time period, the determination process of the abnormal state is not performed. Thus, it is possible to reliably detect whether or not the inlet side sealing valve and the outlet side sealing valve are abnormal.

(5) Further still, the processor causes the fuel cell system to determine, in the determination process of the abnormal state, that there is a malfunction in at least one of the inlet side sealing valve or the outlet side sealing valve in the case that the abnormal state is determined a plurality of times in succession.

In accordance with such a configuration, a malfunction of the sealing valves can be accurately determined.

(6) Further still, the processor causes the fuel cell system to determine, in the determination process of the abnormal state, that there is a malfunction in at least one of the inlet side sealing valve or the outlet side sealing valve when the abnormal state is determined again as a result of the determination process of the abnormality state after at least one of the inlet side sealing valve or the outlet side sealing valve is driven to be in an open state after the abnormal state is determined.

In accordance with such a configuration, it is possible to avoid a situation in which the abnormality determination processes are executed consecutively in the same driving state of the inlet side sealing valve and the outlet side sealing valve.

(7) Further still, the processor causes the fuel cell system to, in the determination process of the abnormal state, perform a determination process of the abnormal state in the case that the anode pressure is automatically increased by the timer after a first threshold time period has elapsed from the time when the system is stopped or a time when soaking is started a next time, after having driven at least either one of the inlet side sealing valve or the outlet side sealing valve to be in the open state after having determined the abnormal state, and perform a determination process of the abnormal state also in the case that the user activation is carried out after the second threshold time period which is shorter than the first threshold time period has elapsed from the time when the system is stopped or the time when soaking is started the next time.

In accordance with such a configuration, it is possible to avoid a situation in which the abnormality determination processes are executed consecutively in the same driving state of the inlet side sealing valve and the outlet side sealing valve.

The present invention is not limited to the above disclosure, and various modifications are possible without departing from the essence and gist of the present invention.

1. A fuel cell system configured to generate electrical power by way of an electrochemical reaction taking place between an oxygen-containing gas passing through an inlet side sealing valve from an air compressor and being supplied to a cathode flow path along a cathode of a fuel cell, and a fuel gas supplied from a fuel tank to an anode flow path along an anode of the fuel cell, wherein an oxygen-containing off gas after the generation of electrical power passes through an outlet side sealing valve and flows to the exterior, the fuel cell system comprising:
a voltage sensor configured to detect an output voltage between the anode and the cathode; and
at least one processor configured to execute computer-executable instructions stored in a memory;
wherein
the at least one processor executing the computer-executable instructions causes the fuel cell system to:
continue to generate electrical power at a time when the system is stopped, and after having consumed the oxygen-containing gas remaining from an outlet side of the inlet side sealing valve to an inlet side of the outlet side sealing valve, together with driving the inlet side sealing valve and the outlet side sealing valve to place the inlet side sealing valve and the outlet side sealing valve in a closed state, carry out an electrical power generation process at a time of stoppage in which the supply of the fuel gas from the fuel tank to the anode flow path is suspended; and
determine that the inlet side sealing valve or the outlet side sealing valve is in an abnormal state of being in an open state when the output voltage is detected by the voltage sensor and the detected output voltage is greater than or equal to a threshold voltage value, in the case that the fuel gas is newly supplied to the anode flow path after having completed the electrical power generation process at the time of stoppage, in a state in which the inlet side sealing valve and the outlet side sealing valve are driven and placed in the closed state.

2. The fuel cell system according to claim 1, wherein:
a pressure sensor configured to detect a fuel gas pressure is provided in the anode flow path; and
at a time when the fuel gas pressure detected by the pressure sensor is increased up to a threshold gas pressure value, the processor causes the fuel cell system to stop the supply of the fuel gas and to end the electrical power generation process at the time of stoppage.

3. The fuel cell system according to claim 1, further comprising a timer, wherein the processor causes the fuel cell system to determine that a time when the fuel gas is newly supplied to the anode flow path after the electrical power generation process at the time of stoppage is carried out is a time of user activation in which the fuel cell system after stoppage of the system in which the inlet side sealing valve and the outlet side sealing valve are driven and placed in the closed state is activated by the user, or alternatively, is a time when the anode pressure is automatically increased by the timer.

4. The fuel cell system according to claim 3, wherein the processor causes the fuel cell system to,
perform a determination process of the abnormal state in the case that the anode pressure is automatically increased by the timer after a first threshold time period has elapsed from the time when the system is stopped or a time when soaking is started, and
also perform the determination process of the abnormal state in the case that the user activation is carried out after a second threshold time period which is shorter than the first threshold time period has elapsed from the time when the system is stopped or the time when soaking is started.

5. The fuel cell system according to claim 4, wherein the processor causes the fuel cell system to determine, in the determination process of the abnormal state, that there is a malfunction in at least one of the inlet side sealing valve or the outlet side sealing valve in the case that the abnormal state is determined a plurality of times in succession.

6. The fuel cell system according to claim 5, wherein the processor causes the fuel cell system to determine, in the determination process of the abnormal state, that there is a malfunction in at least one of the inlet side sealing valve or the outlet side sealing valve when the abnormal state is determined again as a result of the determination process of the abnormality state after at least one of the inlet side sealing valve or the outlet side sealing valve is driven to be in an open state after the abnormal state is determined.

7. The fuel cell system according to claim 4, wherein the processor causes the fuel cell system to, in the determination process of the abnormal state,
perform a determination process of the abnormal state in the case that the anode pressure is automatically increased by the timer after a first threshold time period has elapsed from the time when the system is stopped or a time when soaking is started a next time, after having driven at least either one of the inlet side sealing valve or the outlet side sealing valve to be in the open state after having determined the abnormal state, and
perform a determination process of the abnormal state also in the case that the user activation is carried out after the second threshold time period which is shorter than the first threshold time period has elapsed from the time when the system is stopped or the time when soaking is started the next time.
